(19) United States
(12) Patent Application Publication
(10) Pub. No.: US 2004/0073533 A1
(43) Pub. Date: Apr. 15, 2004

(54) Internet traffic tracking and reporting system

(76) Inventors: Boleslaw Mynarski, Monmouth Junction, NJ (US); Thomas Dinyovszky, Somerset, NJ (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/269,296

(22) Filed: Oct. 11, 2002

(51) Int. Cl. G06F 7/00

(52) U.S. Cl. 707/1

(57) ABSTRACT

A reporting system and method that works with conventional network management systems to provide long term tracking capability for all network conversations with data provided by, e.g., a company owned commercial software system. The conventional network management system gathers the data frames and a data file is exported after a collection of network conversations that contains only the information needed for reporting. Such information may include, e.g., times, dates, computer addresses, and counters. This data is captured by the reporting system of the invention, filtered, normalized, and stored in a database in such a fashion that unique searches may be applied to the stored data to provide the network administrator with detailed information concerning the usage of the data by particular individuals, the usage of certain data ports, and how much traffic to a specific site on the Internet is generated by network users.

### I. BACKGROUND

A. Field of the Invention

The present invention relates generally to systems and methods for tracking all conversations between a closed network and the Internet and for generating detailed, searchable reports for network administrators for use in, e.g., providing security checks, checking for Internet abuse, and monitoring Internet usage levels by network users.

B. Description of the Prior Art

Network monitoring and management systems are known that sample the data packets on a network and, from these data packets, build database objects that are stored in a database. The database is then subjected to analysis routines in a database management system to extract and display information relating to performance specifications and the like. Network managers use the provided information to analyze, optimize and “tune” the performance of the network software application. Systems of this type are disclosed, e.g., by de la Salle in U.S. Pat. Nos. 5,878,420 and 6,144,961.

Such network management systems utilize collection probes on a network to read the information on the network data frame as such data frame passes by. This information may include the computer address the data is coming from and the destination address. Every predetermined period (e.g., 24 hours), the collected information is collected and sorted by an interactive viewer that allows the software to provide the network administrators with statistical information about the network. The network management system also allows the network administrator to export a data file containing all traffic information into an external file that may, in turn, be saved to local disk storage. A commercial system of this type is available from CompuWare, Inc. and is known as ECHOSCOPE™. As indicated in FIG. 1, the ECHOSCOPETM software is loaded one or more probe computers 100 that sit on the local area network (LAN) 200 made up of nodes 1-N and a network server 300 connected to the Internet via firewall 350 so as to receive data from web servers 400. Probe computer 100 captures the data frames passing through the network connection of the probe computer 100 and provides an output folder (CACI) containing the collected data.

Unfortunately, the data provided by such conventional network management systems is not very useful to the network administrator since the data must be searched manually. In other words, no technique is provided that allows the network administrator to collate and search the collected network traffic data so that the network administrator may conduct security checks, monitor Internet abuse, monitor high network usage, and the like. An improvement is desired whereby a network administrator may collect and search such information so as to provide desired statistics for any of the information collected in a report that may be generated on the fly. For example, a tool is desired that allows the network administrator to identify network users that visit adult sites and other Internet sites that are totally unrelated to the purpose for which the network user is allowed to access the network. In particular, a system is desired that allows network administrators to determine where, when, how often and how much traffic network users generate by going to specific Internet sites. The present invention is designed to address these needs in the art.

### II. SUMMARY OF THE INVENTION

The reporting system of the invention works with conventional network management systems such as the ECHOSCOPE™ system provided by CompuWare to provide long term tracking capability for all network conversations with data provided by, e.g., a company owned commercial software system. In accordance with the invention, the conventional network management system gathers the data frames and a data file is exported after a collection of network conversations that contains only the information needed for reporting. Such information may include, e.g., times, dates, computer addresses, and counters. This data is captured by the reporting system of the invention, filtered for TCP/IP addresses, normalized, and stored in a database in such a fashion such that unique searches may be applied to the stored data to provide the network administrator with detailed information concerning the usage of the data by particular individuals, the usage of certain data ports, and how much traffic to/from a specific site on the Internet is generated by network users.

The reporting tool of the invention allows the network administrator to identify network abuses, to identify the nature and cause of peak network usage, and to identify potential network security breaches. The network tool of the invention also provides for endpoint-to-endpoint traffic monitoring on a network with or without port access to the Internet.

### III. BRIEF DESCRIPTION OF THE DRAWINGS

These and other features, aspects, and advantages of the invention will become better understood in connection with the appended claims and the following description and drawings of various embodiments of the invention where:

FIG. 1 illustrates a prior art network monitoring and maintenance system of the type provided in the ECHOSCOPE™ product sold by CompuWare.

FIG. 2 illustrates a network monitoring and maintenance system including an Internet tracking and reporting system in accordance with the invention.

FIG. 3 illustrates an exemplary user interface for querying the reporting system of the invention.

FIG. 4 illustrates an Internet traffic report generated from the query illustrated in FIG. 3.

FIG. 5 illustrates an Internet traffic report for a particular user of the network.

FIG. 6 illustrates the resolution of the user of FIG. 5 against the domain name on a DNS server for that user.

FIG. 7 illustrates an Internet traffic report including the number of times that a local user or source visited a particular web site in a predetermined time frame, sorted by date.

FIG. 8 illustrates the resolution of the IP address against the domain name on a DNS server for the results of FIG. 7.

FIG. 9 illustrates an Internet traffic report that results when the user selects the destination link in FIG. 4, whereby a listing of all of the users that have visited a web site in a predetermined time frame is returned, grouped by date.

FIG. 10 illustrates an Internet traffic report that lists visitors to particular web sites on particular dates, sorted by hour.

FIG. 11 illustrates an Internet traffic report that lists the users that have visited the web site link of FIG. 10 in a predetermined time frame, sorted by date.

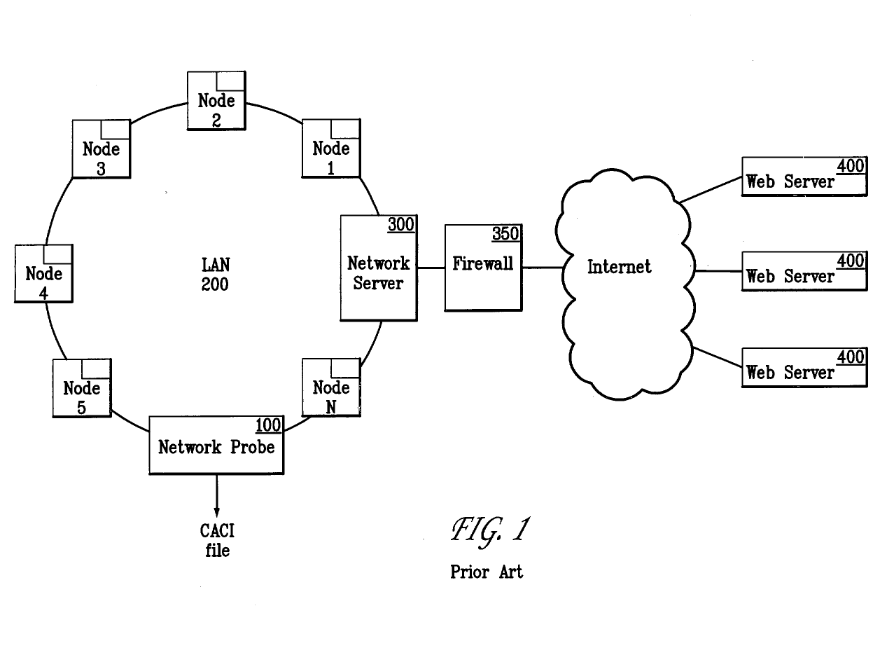

### IV. DETAILED DESCRIPTION

Throughout the following detailed description similar reference numbers refer to similar elements in all the drawings.

The Internet usage tracking and reporting system of the invention is a web based system developed to track network traffic and report on it effectively. As will be appreciated by those skilled in the art, the invention may be implemented on a number of hardware/software platforms (e.g., PC with Windows OS or Linux OS) and operate in conjunction with any of a number of network management systems (e.g., CompuWare ECHOSCOPE™) that may be used to track all endpoint-to-endpoint traffic on the entire network. Typically, none of the interim network devices, such as switches and routers, are tracked. In an embodiment implemented by the present inventors, the system of the invention is loaded on a server running the Linux OS and is used in conjunction with the CompuWare ECHOSCOPE™ network management software package. Of course, those skilled in the art will appreciate that other hardware and software systems may be used to implement the teachings of the invention.

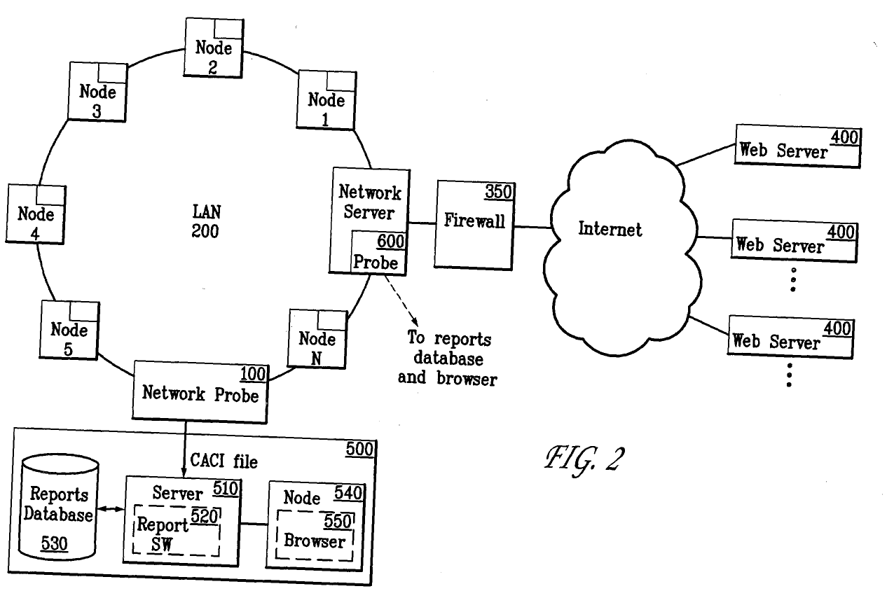

As illustrated in FIG. 2, the Internet usage tracking and reporting system 500 of the invention receives raw network tracking data in a CACI file generated by network probe software 100 such as, e.g., CompuWare's ECHOSCOPE™ software package. As noted above, such network probe software captures all endpoint-to-endpoint traffic on the entire network 200 and dumps the collected data periodically (e.g., every night) to a CACI file. In accordance with the invention, the CACI file is dumped to a folder on the server 510 that is shared with, e.g., a Linux system. The report software 520 described below processes the received data for storage in a reports database 530 for indexing and searching in accordance with the invention. An administrator node 540 provides access to the data stored in the database 530 via a conventional browser 550.

Thus, the network probe 100 collects traffic data from the network 200 for 24 hours and creates a CACI file every 24 hours. This CACI file data is saved to a disk of server 510 for processing by the reporting system software 520. As will be described below, this processing includes importing the data file, filtering the data, populating a traffic table, normalizing the data, and applying query tools.

Upon receipt of the CACI file, the data in the CACI file is imported into a traffic table that is the main data table within the reporting software 520. All imported data is maintained in the traffic table for a predetermined period of time such as, for example, three months. This traffic table is stored in the reports database 530 and becomes the table on which all search queries are run. In a present embodiment, the traffic table has numerous fields that are indexed by the date, time, and endpoints identified for the data.

When the reporting software 520 acknowledges that a new raw data file has been received in the CACI folder, the first thing it does is to check the existing traffic table for records older than the predetermined period of time, e.g., three months. All records older than three months are copied/exported to a new archive file and compressed using data compression software such as Gzip and archived using a GNU archiving utility, such as TAR, that is used in conjunction with Gzip to archive and compress old data. The archived files preferably remain available for retrieval at any time. A check is preferably run to verify that the records older than three months were successfully transferred to the archive file. If the export was successful, then the original records from the traffic table are purged. The traffic table is then optimized and/or re-indexed before importing and/or appending the new raw data.

Before storage in the traffic table, the new raw data is first filtered by the report software 520 to accept only TCP/IP protocol. The database then filters through the TCP/IP data for only records that have passed through well-known (acceptable) network ports. Once the data has been filtered for these two criteria, it is normalized for upload to the reports database 530. During the normalization process, certain data is removed from the raw data and other data is reformatted into a common format using tools such as pattern scanning and processing language (awk) used within a command language interpreter (shell) environment and a stream editor (sed) is used to perform basic text transformations on a file. For example, all quotes (“), all leading spaces, all spaces following commas, and all brackets ([and]), all letters are converted to lower case, and the date is reformatted, as necessary, to yyyy-mm-dd, while the time is reformatted as hh:mm:ss, as necessary. The normalized data is then uploaded to the traffic table, ready for query.

Once the data is successfully housed within the reporting system database 530, queries can be run against the data using, e.g., the following database search tools: an open source (Apache) web server, practical extraction and report language (PERL), and/or an open source SQL-based relational database server such as MySQL. The user initiates the query at node 540 using browser software 550. Generally, the user is given several options to choose from in deciding what information he or she would like to view. For example, the user may elect to sort the stored data by date, time, destination web site, local user (originating computer system from which the network connection was initiated), and/or transfer size. The user may elect to obtain the search results in ascending or descending order and to select how many results to see. The user interface preferably contains a query field where the user may type in the specific search criteria, based on the selection of the field in the traffic table to be searched: destination web site, date, time, local user (source), or transfer size. Preferably, the interface also permits the user to narrow the search as necessary by using an “ignore” field and Boolean operators such as “and,” “and not,” “or,” or “or not.” This second level query may also be limited to any of the aforementioned query fields. The user interface may also give the user the option of electing to resolve any unresolved IP addresses to their host names at run time.

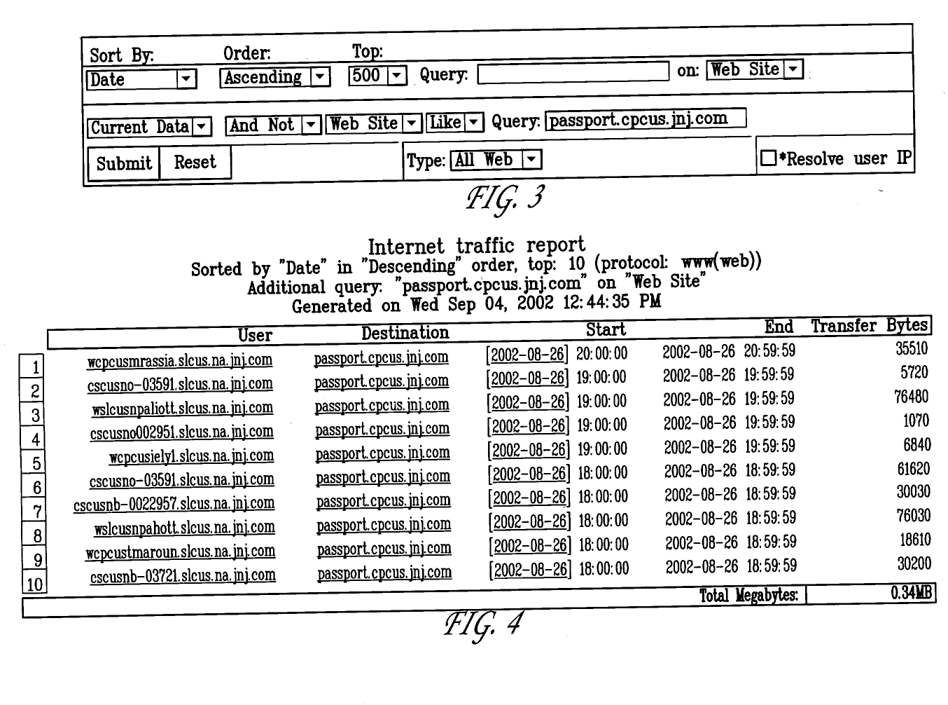

FIG. 3 illustrates an example user interface of the type just described. As illustrated, a number of query options are possible. The “top” field is designed to permit the user to limit the number of results that his/her query will return. This is desirable because queries that return a large number of results can lock the Internet browser software 550. Once the user has seen the limited number of records, he or she can elect to “drill down” to find the exact information that he/she is searching for. On the other hand, if the user does not elect any of the query options and simply hits “submit,” then the system will return the last 10 records imported to the reports database 530.

As indicated in FIG. 3, the user has the option of not selecting any query criteria on the first line of the query page but to make selections on the secondary line. In the example in FIG. 3, the user has selected 500 records in ascending order by date on the first line, while selecting “and not,” “web site” and “passport.cpcusjnj.com” on the second line. This search will return the last 500 records that were any website other than the listed page. On the other hand, the user may select “all” in the “top” field, whereby the report software 520 will not actually return all individual records but rather will return a number of records that matches the query requirements.

Preferably, the query field also allows the user extra searching capabilities through the use of a symbol allowing multiple query commands such as “|” that are treated as Boolean “or” functions. Thus, when entering the search criteria into the query field, the user may enter more than one search criteria that the report software 520 will treat as “or” functions. For example, the query: 2002-05-25|2002-06-07|2002-07-01 on: Date will bring back the records from all three dates. This can be done using either the top or the secondary query fields.

In a presently preferred embodiment, all query results are color coded to show which destination sites, if any, listed in the query results match an “Adult Material” criteria. This allows the system administrator to easily determine at a glance who is accessing improper sites using the company's network, when, and how much data flow is caused by such improper network usage. The “Adult Material” criteria may be established in any of a number of ways known to those skilled in the art, such as through the use of URL/web address pattern matching. Exclusionary criteria is also included for instances where the string pattern may be part of a valid word. For example, “sex” may be an Adult Material string pattern, while its use in “Middlesex” is appropriate.

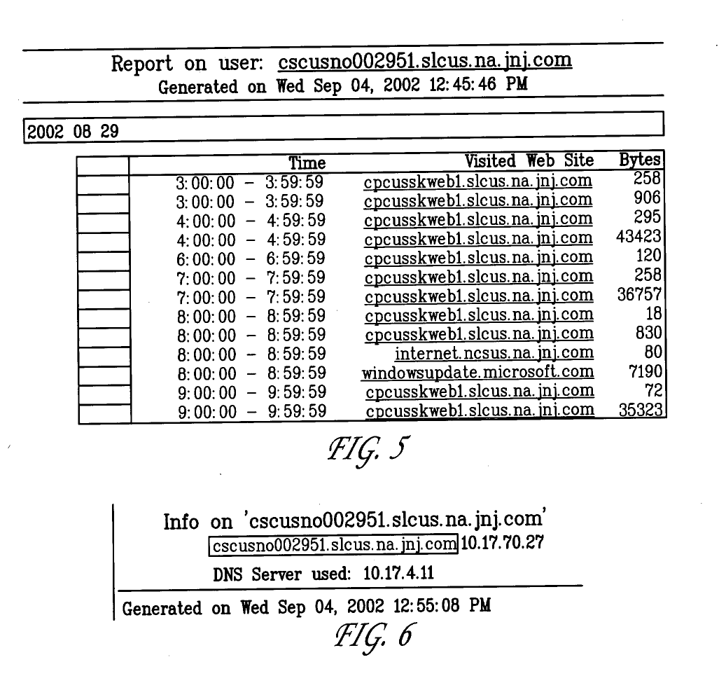

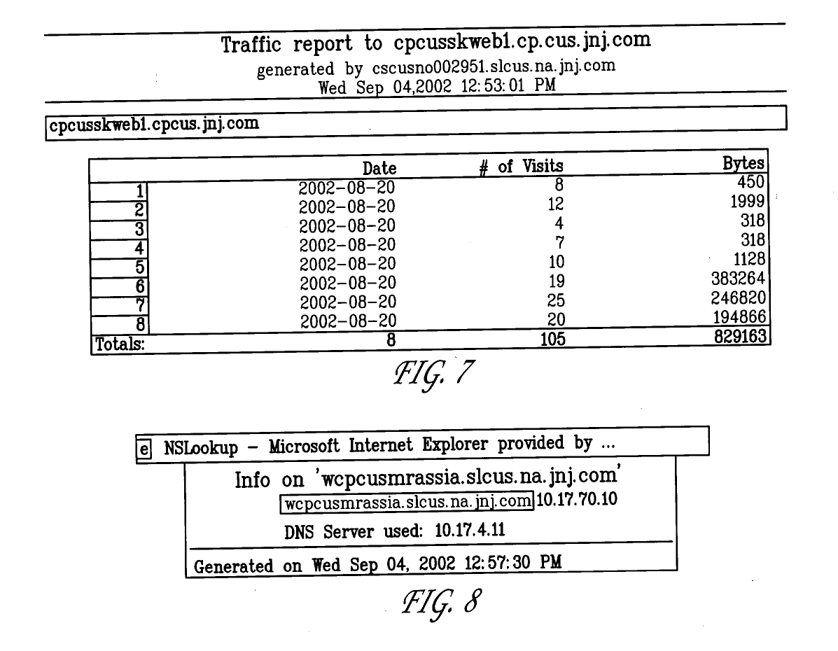

As noted above, the user may “drill down” into the initial query results. For example, in the case of the data illustrated in FIG. 4 returned in response to the inquiry illustrated in FIG. 3, the user may select the indicated row number, to the left of the record, to bring back from reports database 530 all data for that particular user in the database. FIG. 5 illustrates this data for the selected user (4 in FIG. 4). In addition, selecting the user name at the top of FIG. 5 will resolve the IP address against a DNS (domain name resolution) server, and the results will appear on the original query screen as shown in FIG. 6.

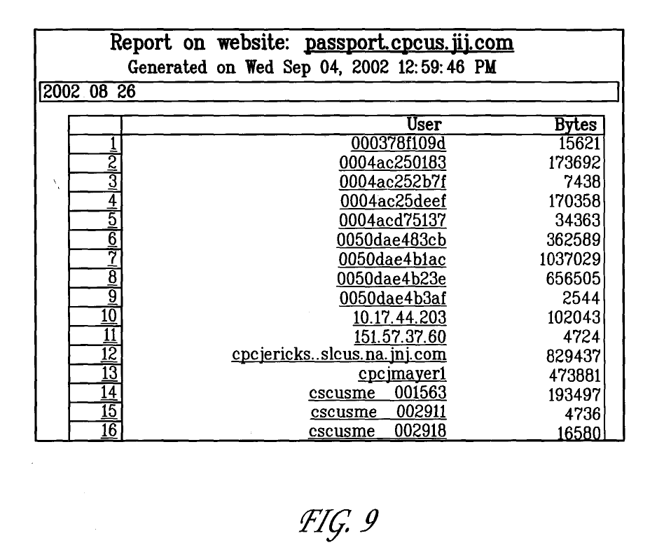

Selecting the visited web site address in FIG. 6 will show the number of times that the local user or source visited that particular site in the last three months, sorted by date, as shown in FIG. 7. Selecting the user link further in FIG. 7 further resolves the IP address against a DNS server, as shown in FIG. 8.

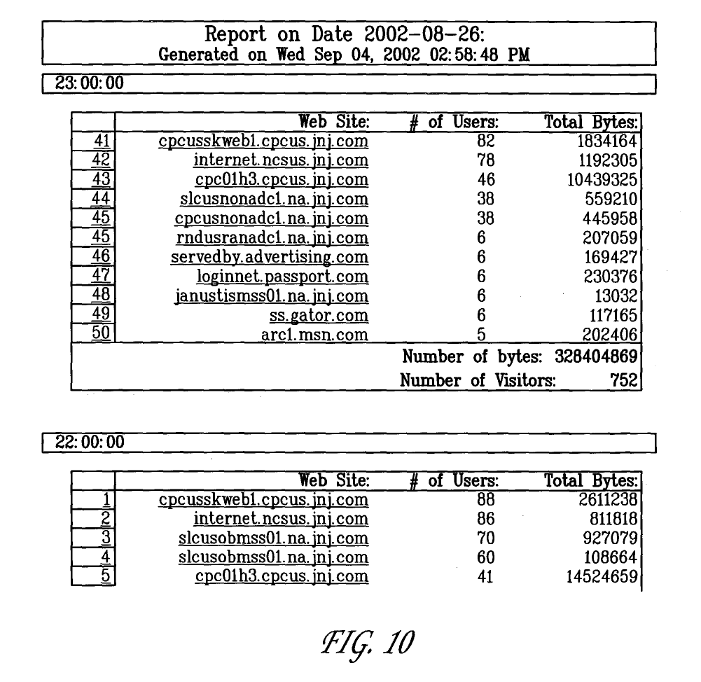

On the other hand, if the user selects the destination link in FIG. 4, all of the users that have visited that site in the last three months will be returned, grouped by date, as shown in FIG. 9. In FIG. 9, selecting the web site link at the top of the page preferably takes the user to the indicated web site to evaluate what the user has been accessing. The features of FIGS. 5-8 may also be used to “drill down” on the contents of FIG. 9.

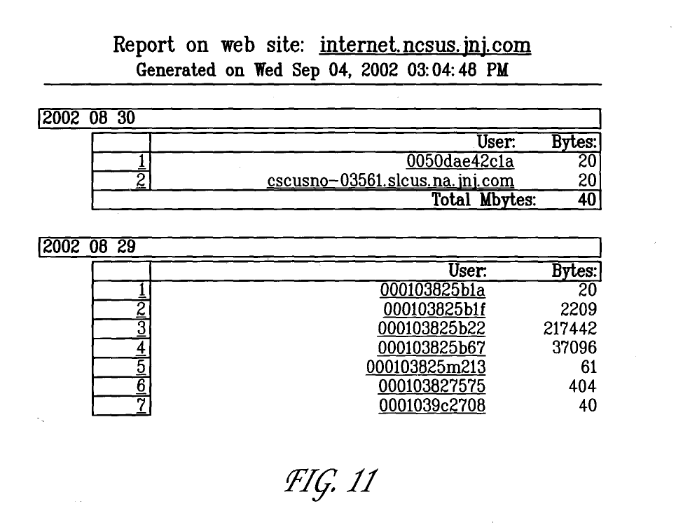

If one were to select the “start date” in FIG. 4, all traffic data for that date will be returned. Preferably, a prompt is provided to limit the number of records returned so as to prevent the system from attempting to return too many records. The records for the selected date are returned for that date, sorted by hour. The record limit selected preferably determines how many records to return for each hour in that day, as shown in FIG. 10. Further, selecting the web site link in FIG. 10 will show the user all of the local users and sources that have visited the listed web site in the last three months, sorted by date, as shown in FIG. 11. Once again, the features of FIGS. 5-8 may also be used to “drill down” on the contents of FIG. 11.

Those skilled in the art will appreciate that the interface functionality described above permits the network system administrator to monitor Internet usage by time of day, destination, and the like, and to determine who the heavy users are so that appropriate decisions may made affecting network operations. Such search capability also allows the network administrator to closely monitor potential security breaches, Internet abuse, and the like. For example, repeated access to a network by outsiders may be readily monitored to determine the frequency of such occurrences and whether the source address is an appropriate address for a customer. The present invention also provides a tool by which access to improper sites on company time may be monitored and addressed by management. Also, since volume usage may be monitored, the report system of the invention provides data that allows the system administrator to determine when network traffic is typically lightest so that network updates, reports, etc. may be run at times of light usage. In short, the invention allows network administrators to track Internet traffic with nearly 100% accuracy and to notify system administrators of where, what time, how often and how much traffic users generate by going to specific sites. The network administrator may then use this traffic information for network administrative planning.

While the invention has been described in connection with the embodiments depicted in the various figures, it is to be understood that other embodiments may be used or modifications and additions may be made to the described embodiments for performing the same function of the invention without deviating from the spirit thereof. For example, those skilled in the art will appreciate that the network probe 100 may be incorporated into the network server 300 as probe 600 illustrated in FIG. 2. In this case, the functions of server 510 would be replaced by network server 300. The reports database 530 and administrative node 540 with browser 550 would then communicate directly with the network server 300. Of course, in a network configuration, these components need not be located in the same physical location so long as the components are logically connected as indicated in FIG. 2. Therefore, the invention should not be limited to any single embodiment, whether expressly depicted and described herein or not. Rather, the invention should be construed to have the full breadth and scope afforded by the claims appended below.

We claim:

1. An Internet traffic tracking and reporting system for a local network, comprising:
a network probe that captures data identifying data traffic to or from any of the nodes on the local network and outputs the captured data on a periodic basis;
a reports database;
a reporting system that imports the captured data output by the network probe, normalizes the captured data, stores the normalized data in the reports database; and provides an interface to a user for querying the normalized data in the reports database; and
an input/output device that enables the user to access the reporting system's interface and to provide search queries into the data stored in the search database, whereby the user may query the reports database to sort the stored data by at least one of date, time, destination web site, originating computer from which a network connection was initiated, and data transfer size.

2. A system as in claim 1 wherein the reporting system archives data that has been stored in the reports database longer than a predetermined time interval.

3. A system as in claim 1, wherein the reporting system filters the received captured data to accept for storage only captured data that is in TCP/IP protocol and that has passed through an acceptable Internet port of the local network.

4. A system as in claim 1, wherein the reporting system's interface color codes query results to identify Internet traffic to web sites believed to contain improper material for access by users of the local network.

5. A system as in claim 1, wherein query results are presented to the user with embedded links whereby the user may “drill down” into the data by selecting an embedded link.

6. A system as in claim 5, wherein the query results include at least one user name and a selection of an embedded link to a user name resolves the IP address of the user against a domain name resolution server to identify the network address of the user.

7. A method of tracking Internet traffic by users of a local network and storing the tracking results for querying by a user, comprising the steps of:
capturing data identifying data traffic to or from any of the nodes on the local network;
outputting the captured data on a periodic basis;
normalizing the output captured data for storage in a reports database;
providing an interface to a user for querying the normalized data in the reports database; and
processing a user's search queries to the reports database to selectively sort the stored data by at least one of date, time, destination web site, originating computer from which a network connection was initiated, and data transfer size.

8. A method as in claim 7 comprising the further step of archiving data that has been stored in the reports database longer than a predetermined time interval.

9. A method as in claim 7, comprising the further step of filtering the outputted captured data to accept for storage in the records database only captured data that is in TCP/IP protocol and that has passed through an acceptable Internet port of the local network.

10. A method as in claim 7, comprising the further step of color coding query results to identify Internet traffic to web sites believed to contain improper material for access by users of the local network.

11. A method as in claim 7, comprising the step of providing embedded links in query results whereby the user may “drill down” into the data by selecting an embedded link.

12. A method as in claim 11, comprising the step of identifying the network address of the user using a domain name resolution server.
